(19) United States
(12) Patent Application Publication
(10) Pub. No.: US 2005/0071600 A1
(43) Pub. Date: Mar. 31, 2005

(54) Memory module and memory support module

(75) Inventor: Motohiko Bungo, Nagoya-shi (JP)

Correspondence Address: Yokoi & Co.;U.S.A., Inc., 13700 Marina Pointe Drive #1512, Marina Del Rey, CA, 90292, US

(73) Assignee: MELCO HOLDINGS INC., Aichi (JP)

(21) Appl. No.: 10/912,321

(22) Filed: Aug. 5, 2004

(30) Foreign Application Priority Data
Aug. 8, 2003 (JP) JP2003-206790

(51) Int. Cl. G06F 12/00

(52) U.S. Cl. 711/170; 711/115

(57) ABSTRACT

It is aimed at not only enabling access to an inaccessible SDRAM area from a PC which only outputs A0 through A11 signals, but also making a common memory module connectable to earlier or latest PCs independently of their models. According to the construction, a connected PC (computer) inputs a high-order address signal A12. It is determined whether or not the input A12 signal is set to a state different from an unused state. A determination signal is generated so as to indicate a state corresponding to a determination result. When the determination signal indicates a changed state, the PC inputs A0 through A12 signals and supplies them to a memory chip 20. When the determination signal indicates an unchanged state, the PC inputs A0 through A11 signals and a select signal. The A12 signal is generated based on the input select signal. The memory chip 20 is supplied with the A12 signal and the input A0 through A11 signals.

### BACKGROUND OF THE INVENTION

1. Field of the Invention

The present invention relates to a memory module and a memory support module connectable to a computer body.

2. Description of Related Art

Conventionally, computer memories are expanded by connecting a memory module to a computer's socket (slot) Available memory modules include a 128-Mbyte DIMM (Dual Inline Memory Module) comprising eight 128-Mbit SDRAM (Synchronous Dynamic Random Access Memory) chips and a 256-Mbyte DIMM comprising 16 128-Mbit SDRAM chips. Normally, the 128-Mbit SDRAM is provided with 12 address signal terminals A0 through A11 connectable to 12 signal lines for row addresses and 10 signal lines for column addresses. When a computer inputs address signals A0 through A11, it is possible to read or write data at the corresponding addresses for all 128-Mbit areas in the entire SDRAM.

The above-mentioned 256-Mbyte DIMM is divided into two blocks (banks) of SDRAM groups. In addition to address signals A0 through A11, the computer inputs a plurality of chip select signals corresponding to a plurality of banks of SDRAM groups to be accessed. This makes it possible to read or write data at the corresponding banks and addresses for all 256-Mbyte areas in the DIMM. In this manner, it is possible to increase the memory capacity the computer can handle by using a plurality of chip select signals to select either of banks.

According to the technology as disclosed in JP-B No. 3022255 (see patent document 1), there is also known a module that selects a memory chip to be accessed in accordance with a state of the highest-order address signal input from the computer.

[Patent document 1]

JP-B No. 3022255 (paragraphs 0014 to 0054, FIGS. 1 to 8)

The above-mentioned prior art is subject to the following problems.

In recent years, there is a trend of using a 256-Mbyte DIMM comprising eight 256-Mbit SDRAMs. Accessing all memory areas of the 256-Mbit SDRAM needs to input signals at row addresses A0 through A12 to the SDRAM. Since an earlier model of computer only outputs address signals for A0 through A11, it has been possible to simply connect that DIMM, but only handle a 128-Mbit area, i.e., a half of the 256-Mbit SDRAM. The use of the module disclosed in JP-B No. 3022255 simply changes the memory chip to be accessed in accordance with a state of the highest-order address signal A11. The problem remains unsolved.

There has been a demand for providing common memory modules independently of models of computers.

### SUMMARY OF THE INVENTION

The present invention has been made in consideration of the foregoing. It is therefore an object of the present invention to provide a memory module and a memory support module capable of being connected to computers independently of models thereof and normally accessing memory chips.

In order to achieve the above-mentioned object, the present invention provides a standardized memory module which is mounted with a memory chip having a stepwise varying capacity based on a specified multiple and, when connected to a computer, enables data access correspondingly to a specified number of address signals and a select signal to indicate a selected or unselected state of a memory space having a capacity corresponding to the specified number of address signals, wherein any of the address signals corresponds to the stepwise varying memory chip capacity; and wherein the memory module comprises: a memory circuit capable of virtually scaling down the memory chip capacity when the computer does not comply with the capacity of mounted memory chip; and a determination circuit which determines an operation of the memory circuit by determining whether or not the computer complies with the capacity of mounted memory chip.

When the memory module is mounted on a computer compliant with the capacity of memory chips, the determination circuit determines that the computer complies with the capacity of mounted memory chips to determine an operation of the memory circuit. The memory circuit then enables data access correspondingly to the capacity of mounted memory chips. When the memory module is mounted on a computer noncompliant with the capacity of memory chips, the determination circuit determines that the computer does not comply with the capacity of mounted memory chips to determine an operation of the memory circuit. The memory circuit then enables data access by virtually scaling down the memory chip capacity.

If the computer does not comply with the memory chip capacity, data access is available by virtually scaling down the memory chip capacity. Such computer can appropriately access the memory chips. Of course, when the computer complies with the memory chip capacity, data access is available correspondingly to the capacity of mounted memory chips. Such computer can appropriately access the memory chips. Accordingly, a common memory module can be provided independently of earlier or latest models of computers, eliminating the need to manufacture memory modules specific to models.

The present invention of an embodiment connects the standardized memory module to the first or second computer, enabling access to memory chips from the computer. A memory chip mounted on the memory module is supplied with the specified number of address signals and the high-order address signal to enable access to corresponding data.

When the memory module is connected to the second computer, the computer inputs the specified number of address signals to the memory circuit. The specified number of address signals includes the high-order address signal that can be set to a state different from the unused state. The determination circuit generates a determination signal indicating the changed state. At this time, the memory chip is supplied with the specified number of address signals from the connected computer. Accordingly, the computer can access data corresponding to the specified number of input address signals.

When the memory module is connected to the first computer, the computer supplies the memory circuit with a second specified number of address signals, a high-order address signal always set to the unused state as specified, and a plurality of select signals indicating the selected or unselected state for each memory space having the capacity corresponding to the second specified number of address signals. The determination circuit then generates a determination signal indicating the unchanged state. At this time, the memory circuit generates the high-order address signal based on the select signal. The generated high-order address signal is supplied along with the specified number of input address signals to memory chips. The computer can access data corresponding to the generated high-order address signal and the second specified number of input address signals.

If the memory chip does not allow access to all memory areas only through the use of the address signals supplied from the computer, an address signal is generated other than the second specified number of address signals based on the select signal. The computer can access memory areas that cannot be accessed only through the use of the address signals. For example, an earlier model computer may output an address signal that can only access all memory areas in DRAM of 128 Mbits or less. It becomes possible to access a memory area exceeding 128 Mbits in DRAM of 256 Mbits or more. If the memory module is connected to a latest model computer that can access more memory areas, it is possible to access memory areas of the capacity corresponding to all the input address signals. Accordingly, a common memory module can be provided independently of earlier or latest models of computers, eliminating the need to manufacture memory modules specific to models.

Of course, the present invention can be applied to memory chips of various memory capacities.

There may be provided one or more memory chips described above. The memory chip may be capable of not only writing and reading data, but also writing data only. The memory chip may be also capable of reading data only. These cases are also applicable to the access capability according to the present invention. Therefore, it is possible to use various memory chips such as SDRAM, ROM, and the like.

Generating the high-order address signal makes it possible to access all areas of the memory chip. It is convenient to be able to effectively use the memory capacity. Since the high-order address signal just needs to be an address signal added to the second specified number of address signals, however, it is not necessary to be able to access all areas of the memory chip. Also in this case, the high-order address signal can be generated and supplied to the memory chip. It is possible to access a memory area having the capacity larger than the memory space having the capacity corresponding to the second specified number of address signals.

Further, the present invention of another embodiment allows the memory chip to accept the memory select signal to indicate the selected or unselected state. When the memory select signal is set to the selected state, it is possible to access data corresponding to the specified number of address signals.

When the memory module is connected to the second computer, the select signal is further input to indicate the selected or unselected state of the memory space having the capacity corresponding to the specified number of address signals. At this time, the memory circuit supplies the memory chip with the specified number of address signals and the select signal from the connected computer. The computer can access data corresponding to the specified number of address signals supplied when the select signal is set to the selected state.

When the memory module is connected to the first computer, the memory circuit further generates the memory select signal based on the select signal. The generated memory select signal is supplied to the memory chip. Therefore, the memory chip becomes accessible when the memory select signal is set to the selected state. Generating the memory select signal can increase the number of memory chips accessible from the computer. It is possible to ensure a large memory capacity the computer can handle.

The present invention is capable of enabling computers to access memory areas that cannot be fully accessed only through the use of address signals input from earlier model computers. The memory areas can be used effectively. The memory module can be also connected to latest computers that can access more memory areas, eliminating the need for memory modules specific to computer models.

The present invention of another embodiment may constitute the memory module as follows. The memory circuit has a power supply line which is supplied with power supply voltage from the first and second computers and supplies power supply voltage to the memory chip. The determination circuit comprises a stabilization determination circuit and a state holding circuit. The stabilization determination circuit determines whether or not a potential of the power supply line is smaller than a specified threshold potential, and generates a reset signal which indicates an on-state when the potential is determined to be smaller than the threshold potential and indicates an off-state otherwise. The state holding circuit determines whether or not the high-order address signal changes from the unused state to a different state only when the reset signal is in an off-state, sets the determination signal to the changed state and holds it when the high-order address signal changes to the different state, and keeps the determination signal in the unchanged state when the high-order address signal remains the unchanged state. Only when the power supply line potential becomes greater than the specified threshold potential to stabilize the power supply voltage, it is determined whether or not the high-order address signal changes from the unused state to a different state. The determination signal can be generated more reliably.

Further, the following constitution maybe available. The memory circuit has nonvolatile memory which stores data to be read before access to the-memory chip. The determination circuit has a read start determination circuit which determines whether or not data starts to be read from the nonvolatile memory when the reset signal changes from an on-state to an off-state, generates an on-state mask signal when determining that readout of the data does not start, and generates an off-state mask signal when determining readout of the data starts. The state holding circuit determines whether or not the high-order address signal changes from the unused state to a different state only when the mask signal is in an off-state, sets the determination signal to the changed state and holds it when the high-order address signal changes to the different state, and keeps the determination signal in the unchanged state when the high-order address signal remains the unchanged state. After the power supply voltage stabilizes and before the memory chip is accessed, it is determined whether or not the high-order address signal changes from the unused state to a different state. The determination signal can be generated much more reliably.

The present invention more reliably generates the determination signal and enables more reliable access to memory chips independently of earlier or latest models of computers to be connected.

Moreover, the following constitution maybe available. The state holding circuit comprises a comparison circuit, a gate circuit, and a hold circuit. The comparison circuit is supplied with the high-order address signal, compares a potential of the high-order address signal with a specified second threshold potential, outputs a comparison result of a specified first potential when the high-order address signal is in the unused state, and outputs a comparison result of a specified second potential when the high-order address signal is in a state different from the unused state. The gate circuit outputs a specified third potential signal when the comparison result indicates the second potential and the mask signal is in an off-state, and outputs a specified fourth potential when the comparison result indicates the first potential or the mask signal is in an on-state. The hold circuit sets the determination signal to the unchanged state when a signal output from the gate circuit indicates the fourth potential, and sets the determination signal to the changed state when a signal output from the gate circuit indicates the third potential. It is possible to provide a specific example to generate the determination signal much more reliably.

The present invention much more reliably generates the determination signal and enables much more reliable access to memory chips independently of earlier or latest models of computers to be connected.

Furthermore, the present invention of another embodiment may constitute the memory module as follows. The memory circuit comprises: a first switch circuit which determines connection to a signal line for a high-order address signal of the memory chip to be a signal line for a high-order address signal from the computer when the determination signal indicates the changed state; and to be a signal line for a high-order address signal generated based on the select signal when the determination signal indicates the unchanged state; and a second switch circuit which determines connection to a signal line for a memory select signal of the memory chip to be a signal line for a select signal from the computer when the determination signal indicates the changed state; and to be a signal line for a memory select signal generated based on the select signal when the determination signal indicates the unchanged state. This makes it possible to reliably change between the high-order address signal supplied to the memory chip and the memory select signal.

There may be various constitutions to generate the memory select signal when the memory module is connected to the first computer. For example, the memory circuit may use the memory select signal to indicate the selected state of the memory chip when any of the plurality of input select signals selects the memory space. The memory circuit may use the memory select signal to indicate the unselected state of the memory chip when all the plurality of input select signals unselect the memory space. In this case, the memory select signal selects the memory chip when the plurality of select signals selects any of the plurality of memory spaces. The memory select signal does not select the memory chip when none of the plurality of select signals selects all of the plurality of memory spaces. In this manner, the memory select signal can be generated appropriately.

For example, let us assume that the select signal and the memory select signal set to low indicate the unselected state. In this case, it is possible to input a plurality of select signals to the AND gate and use an output from the same gate as the memory select signal. Alternatively, let us assume that the select signal and the memory select signal set to high indicate the unselected state. In this case, it is possible to input a plurality of select signals to the OR gate and use an output from the same gate as the memory select signal. When the select signal and the memory select signal use different states to indicate the selected and unselected states, a NAND gate, a NOR gate, and the like can be used to generate the memory select signal.

The first computer may generate two types of select signals to indicate the selected or unselected state for each of two memory spaces having capacities corresponding to the second specified number of address signals. In this case, the memory circuit may be supplied with each of the two types of select signals from the computer, use it as the additional address signal, and supply it to the memory chip. That is to say, a simple constitution can be provided to use either of two types of select signals as the additional address signal and supply it to the memory chip. Of course, when three or more types of select signals are generated, it is also possible to generate the additional address signal from a plurality of select signals.

Some computers output a signal to sleep an unused bank of memory chips for energy saving. In consideration for this, the present invention of another embodiment provides the following constitution. The memory chip is supplied with a pulse-shaped clock signal and a memory clock enable signal to indicate an enabled or disabled state of the clock signal and can operate based on the clock signal when the clock enable signal is enabled. The first computer generates a plurality of clock enable signals to indicate an enabled or disabled state of the clock signal input for each of a plurality of memory spaces having a capacity corresponding to the clock signal and the second specified number of address signals. The second computer generates a clock enable signal to indicate an enabled or disabled state of the clock signal input for a memory space having a capacity corresponding to the clock signal and the specified number of address signals. The memory circuit comprises a third switch circuit which, when the determination signal is set to the changed state, determines connection to a memory clock enable signal for the memory chip to be a signal line for clock enable signal from the computer and, when the determination signal is set to the unchanged state, accepts the clock signal and the plurality of clock enable signals from the computer, generates the memory clock enable signal based on the plurality of clock enable signals, and determines connection to a memory clock enable signal for the memory chip to be a signal line for the generated memory clock enable signal.

The above-mentioned memory chip is supplied with the clock signal and the memory clock enable signal to indicate the enabled or disabled state of the clock signal input. The memory chip can operate based on the clock signal when the clock enable signal is enabled.

When the memory module is connected to the second computer, the computer further supplies the memory circuit with the pulse-shaped clock signal and the clock enable signal that indicates the enabled or disabled state of clock signal input for the memory space having the capacity corresponding to the specified number of address signals. At this time, the clock enable signal from the computer is supplied to the memory chip. The memory chip becomes operative when the clock enable signal from the second computer is set to the enabled state.

When the memory module is connected to the first computer, the computer further supplies the memory circuit with the pulse-shaped clock signal and a plurality of clock enable signals for each of a plurality of memory spaces having capacities corresponding to the second specified number of address signals. At this time, the memory circuit generates the memory clock enable signal based on the plurality of clock enable signals. The memory chip is supplied with the generated memory clock enable signal together with the clock signal. Accordingly, the memory chip becomes operative when the memory clock enable signal is enabled. That is to say, when the computer outputs a plurality of clock enable signals to a plurality of memory spaces, the memory chip can be accessed appropriately.

As mentioned above, it is possible to reliably switch the memory clock enable signal to be supplied to memory chips.

There may be various constitutions to generate the memory clock enable signal when the memory module is connected to the first computer. For example, when any of the plurality of clock enable signals enables clock signal input to the memory space, the memory circuit may use the memory clock enable signal to enable clock signal input to the memory chip. When all of the plurality of clock enables signals disables clock signal input to the memory space, the memory circuit may use the memory clock enable signal to disable clock signal input to the memory chip.

That is to say, when a plurality of clock enable signals enable clock signal input to any of a plurality of memory spaces, the memory clock enable signal enables clock enable signal input to the memory chip. When the plurality of clock enable signals disable clock signal input to all of the plurality of memory spaces, the memory clock enable signal disables clock enable signal input to the memory chip. In this manner, memory clock enable signal can be generated appropriately. The memory clock enable signal can be generated by using the same gates and the like as described for the memory select signal.

Even if a memory module is not mounted with memories, mounting memories can provide the same working effects. In consideration for this, there may be provided a memory support module used for a standardized memory module which can be mounted with a memory chip having a stepwise varying capacity based on a specified multiple and, when the memory module is mounted with the memory chip and is connected to a computer, enables data access correspondingly to a specified number of address signals and a select signal to indicate a selected or unselected state of a memory space having a capacity corresponding to the specified number of address signals. Any of the address signals corresponds to the stepwise varying memory chip capacity. The memory module comprises: a memory circuit capable of virtually scaling down the memory chip capacity when the computer does not comply with the capacity of mounted memory chip; and a determination circuit which determines an operation of the memory circuit by determining whether or not the computer complies with the capacity of mounted memory chip.

That is to say, the present invention is also effective for the memory support module having no memory chips. The constitutions described above can be also applied to the memory support module.

### BRIEF DESCRIPTION OF THE DRAWINGS

FIG. 1 is a front view showing an appearance a memory module according to a first embodiment of the present invention;

FIG. 2 shows partial wiring correspondence between a desktop PC connector and a conventional 128-Mbit SDRAM;

FIG. 3 partially shows terminals of the conventional 128-Mbit SDRAM in each SDRAM group and signal lines connected to the terminals;

FIG. 4 is a timing chart showing states of signals output from a connector of a desktop PC;

FIG. 5 partially shows 256-Mbit SDRAM terminals used for the desktop PC and signal lines connectable to the terminals;

FIG. 6 is a partial circuit diagram of a memory module circuit;

FIG. 7s schematically shows 128-Mbit memory spaces allocated to 256-Mbit memory areas;

FIG. 8 is a timing chart showing states of various signals;

FIG. 9 is a partial circuit diagram of a memory module circuit according to a modification example;

FIG. 10 is a block diagram partially showing signals input to an SDRAM mounted on the memory module according to another modification example;

FIG. 11 is a partial circuit diagram of a memory module circuit according to another modification example;

FIG. 12 is a tabular diagram showing correspondence between states of signals CS0 through CS3 and signals A12 and A13;

FIG. 13 illustrates different states of a high-order address signal output from the PC;

FIG. 14 is a partial circuit diagram of a memory module circuit according to a second embodiment;

FIG. 15 is a circuit diagram showing a determination circuit;

FIG. 16 is a timing chart showing states of various signals connected to a 128-Mbyte compliant PC; and

FIG. 17 is a timing chart showing states of various signals connected to a 256-Mbyte compliant PC.

### DETAILED DESCRIPTION OF THE PREFERRED EMBODIMENTS

Embodiments of the present invention will be described in the following sequence.

(1) Configuration of a memory module according to a first embodiment

(2) Effects of the memory module

(3) Modification examples

(4) Configuration of a memory module according to a second embodiment

### (1) Configuration of a Memory Module According to a First Embodiment

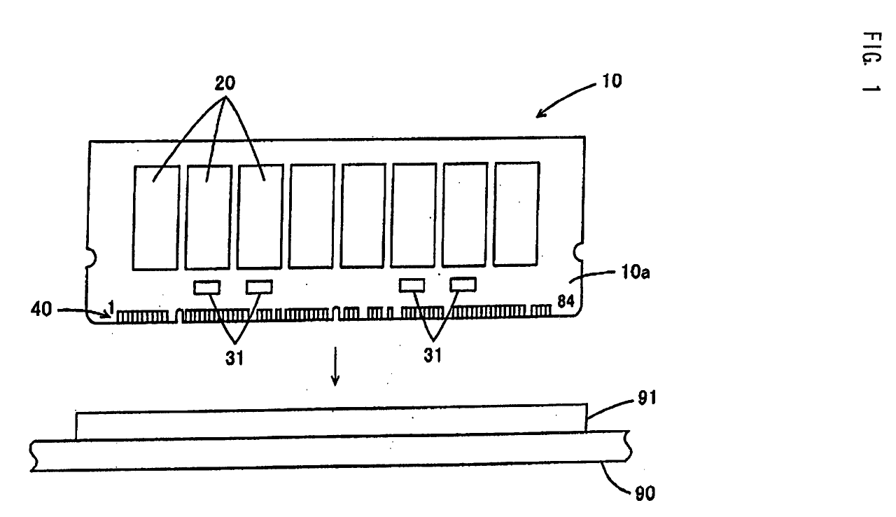

FIG. 1 is a front view showing an appearance a memory module 10 according to the first embodiment of the present invention. FIG. 1 will be used to describe positional relations such as top, bottom, left, and right.

The memory module 10 comprises eight 256-Mbit SDRAMs 20, a plurality of gate ICs 31, a resistor circuit (not shown), and the like, all mounted on a standardized printed circuit board 10a. The SDRAM 20 is a memory chip whose storage capacity varies based on a specified multiple, i.e., 2 to the Na-th power, in accordance with the number of address signals. A 168-pin terminal 40 is formed at the bottom edge of the printed circuit board 10a so that 84 pins are each provided on the front and the rear of the printed circuit board. The memory module 10 is an expansion memory card for desktop personal computers (PCs) The 168-pin terminal 40 compliant with the DIMM specification can be inserted into a connector (slot) of a motherboard 90 of the desktop PC (computer). The connector 91 is provided with 168 conductive sections corresponding to the arrangement of the terminal 40. The connector 91 is shaped to be capable of mounting standardized 168-pin DIMMs. When the memory module 10 is inserted into the connector 91 from the top to the bottom, the memory module 10 can be mounted on the motherboard almost at a right angle for connection to the desktop PC. As a result, the desktop PC can have expanded memory.

The desktop PC for connecting the memory module 10 is not the latest model. The desktop PC handles the 256-Mbyte memory capacity as two banks each containing 128 Mbytes. Accordingly, the desktop PC is suitably configured to expand a 256-Mbyte DIMM comprising 16 128-Mbit SDRAMs, for example.

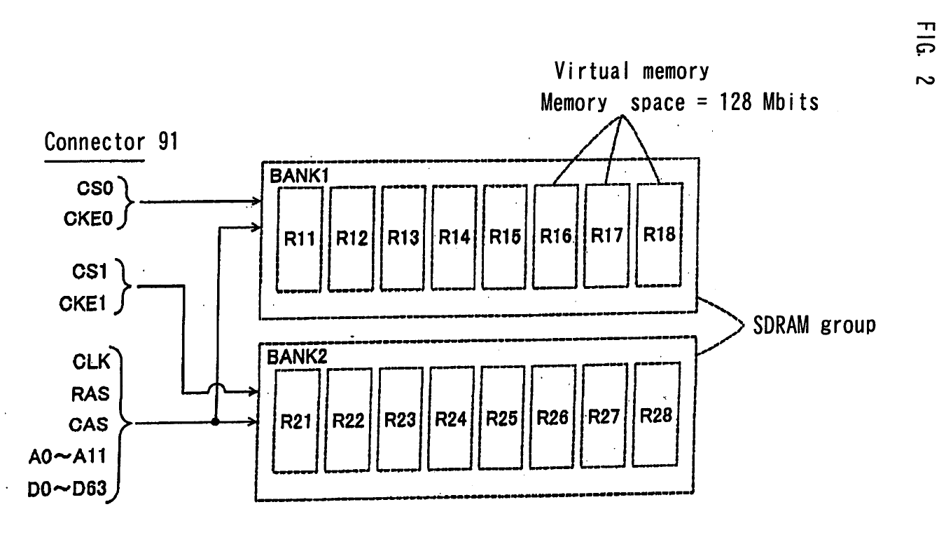

FIG. 2 shows partial wiring correspondence between the connector 91 of the desktop PC (first computer) and a virtual memory space formed by using a conventional 256-Mbyte DIMM comprising 16 128-Mbit SDRAMs.

In FIG. 2, the DIMM is configured to comprise two blocks or banks of SDRAM groups each consisting of eight 128-Mbit virtual memories R11 through R18 and R21 through R28. Let us assume an upper SDRAM group to be BANK1 and a lower SDRAM group to be BANK2 in FIG. 2. The connector 91 has connection sections for various signal lines such as CLK, RAS, CAS, A0 through A11, D0 through D63, CS0, CS1, CKE1, CKE2, and the like.

The CLK signal signifies a clock signal. The PC generates a pulse-shaped clock signal at a specified frequency and supplies it to the CLK signal line.

The RAS (Row Address Strobe) signal signifies a signal that transmits timing to supply a row address to the SDRAM. The CAS (Column Address Strobe) signal signifies a signal that transmits timing to supply a column address to the SDRAM. The A0 through A11 signals signify a second specified number of address signals (12 types) that specify addresses in the memory space. When the DIMM is mounted with a 128-Mbit SDRAM capable of inputting and outputting 8-bit data, the SDRAM is supplied with 12 types of address signals as row addresses and 10 types of address signals as column addresses. The PC generates the RAS, CAS, and A0 through A11 signals and supplies them to the signal lines in accordance with the CLK signal.

The D0 through D63 signals signify 64 types of data signals. The 64 data signal lines are divided into eight sets of eight lines. A set of eight lines is connected to each SDRAM in the SDRAM group.

The CS0 and CS1 signals are chip select signals (select signals) to select an SDRAM group to be accessed. The signals indicate a selected or unselected state of each SDRAM group. The signals are negative logic signals that go L (low) to indicate a selected state of the SDRAM group and go H (high) to indicate an unselected state thereof. The CS0 and CS1 signals do not go L simultaneously. Only one of the signals goes L when accessing the SDRAM.

The CKE1 and CKE2 signals are clock enable signals that indicate an enabled or disabled state of the CLK signal input for each of the two SDRAM groups. The signals are positive logic signals that go H to indicate an enabled state of the clock signal input and L to indicate a disabled state thereof. The PC generates the CS0, CS1, CKE1, and CKE2 signals and supplies them to the signal lines in accordance with the CLK signal.

Further, the connector 91 is formed with connection sections for signal lines corresponding to two types of expanded address signals BA0 and BA1, a power supply line, and the like.

The CLK, RAS, CAS, A0 through A11, and D0 through D63 signals are supplied to both BANK1 and BANK2. The CS0 and CKE0 signals are supplied to BANK1. The CS1 and CKE1 signals are supplied to BANK2.

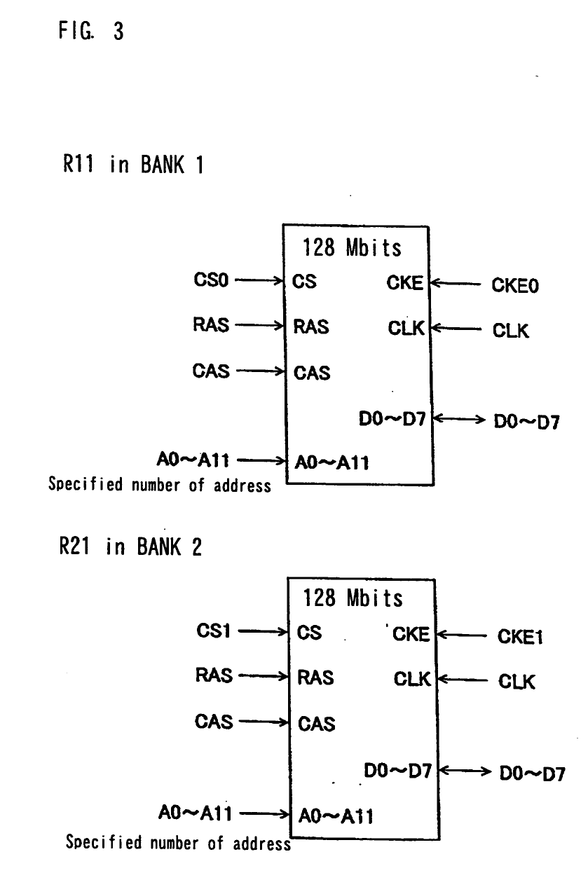

FIG. 3 partially shows terminals of the conventional 128-Mbit SDRAM corresponding to the virtual memory in each SDRAM group and signal lines connected to the terminals. Terminal names are described inside the SDRAM. Signal line names are described outside the SDRAM.

The SDRAM enables access to data corresponding to the A0 through A11 signals when the select signal and the A0 through A11 signals are input and the select signal goes L (selected). The SDRAM can operate based on the CLK signal when the clock enable signal is input to the CKE terminal and the clock enable signal goes H (enabled).

According to the specification, virtual memory R11 in BANK1 allows the CLK, RAS, CAS, A0 through A11, and D0 through D7 signal lines to be connected to clock signal input terminal CLK, row address signal input terminal RAS, column address signal input terminal CAS, address signal input terminals A0 through A11, and data signal input/output terminals D0 through D7, respectively. The corresponding signals are input to or output from the terminals. According to the specification, eight different data signal lines are connected to the data signal input/output terminals D0 through D7 corresponding to the other virtual memories R12 through R18 in the same BANK1. According to the specification, the CS0 and CKE0 signal lines are connected to the a chip select signal input terminal CS and a clock enable signal input terminal CKE, respectively. The chip select signal is input to the CS terminal and indicates whether or not BANK1 is selected. The clock enable signal is input to the CKE terminal and indicates whether or not the clock signal input is enabled for BANK1. According to the specification, the same CS0 and CKE0 signal lines are also connected to the virtual memories R12 through R18.

According to the specification, virtual memory R21 in BANK2 allows the same signal lines as for the virtual memory R11 to be connected to the CLK, RAS, CAS, A0 through A11, and D0 through D7 terminals. According to the specification, the CS1 and CKE1 signal lines are connected to the CS and CKE terminals, respectively. The chip select signal is input to the CS terminal and indicates whether or not BANK2 is selected. The clock enable signal is input to the CKE terminal and indicates whether or not the clock signal input is enabled for BANK2. According to the specification, the same CS1 and CKE1 signal lines are also connected to the virtual memories R22 through R28.

The 128-Mbit SDRAM also has BA0 and BA1 terminals capable of inputting extended address signals. Accordingly, the SDRAM inputs 12 bits for row addresses, 10 bits for column addresses, and 2 bits for extended addresses, i.e., 24 bits in total. The SDRAM inputs or outputs 8-bit data corresponding to addresses and therefore provides a 128-Mbit memory space, i.e., 2 to the 24th power multiplied by eight bits.

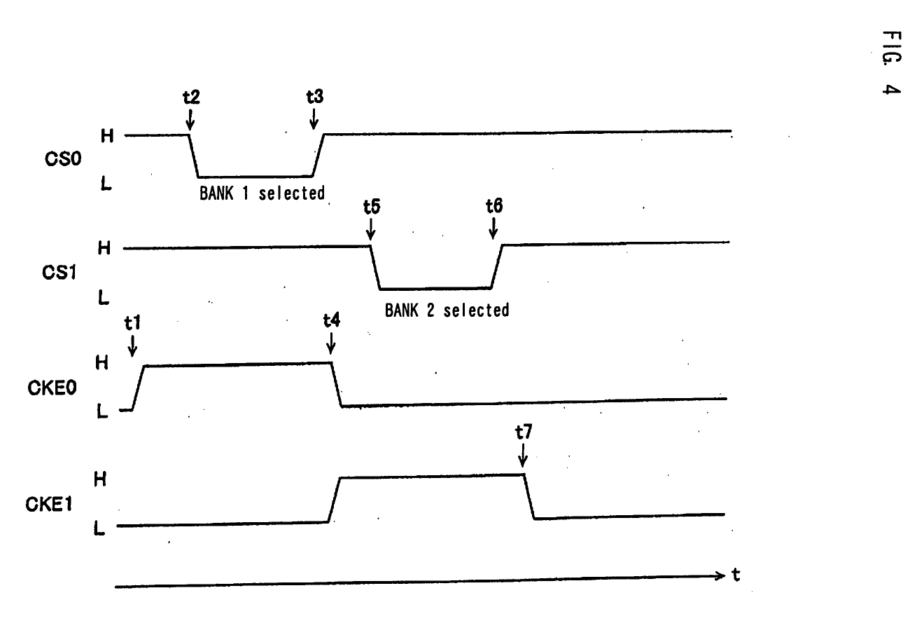

FIG. 4 is a timing chart showing states of signals output from the connector 91 of the desktop PC.

The desktop PC outputs the clock enable signal to sleep an unused bank memory for energy saving. When accessing the BANK1 SDRAM, the desktop PC raises the CKE0 signal from L to H (timing t1) to wake up the SDRAM. To access the SDRAM, the desktop PC lowers the CS0 signal from H to L (timing t2) To terminate access to the BANK1 SDRAM, the desktop PC raises the CS0 signal from L to H (timing t3). To sleep the BANK1 SDRAM, the desktop PC lowers the CKE0 signal from H to L. When accessing the BANK2 SDRAM, the desktop PC raises the CKE1 signal from L to H (timing t4) to wake up the SDRAM. To access the BANK2 SDRAM, the desktop PC lowers the CS1 signal from H to L (timing t5). To terminate access to the SDRAM, the desktop PC raises the CS1 signal from L to H (timing t6). To sleep both BANK1 and BANK2 SDRAMs, the desktop PC sets both CKE0 and CKE1 signals to the L state.

In this manner, the desktop PC generates two select signals each for two memory spaces having the capacity (128-Mbit×8) corresponding to the second specified number of address signals so that the CS0 and CS1 signals do not become L simultaneously. Further, the desktop PC generates two clock enable signals each for two memory spaces so that the CKE0 and CKE1 signals do not become H simultaneously.

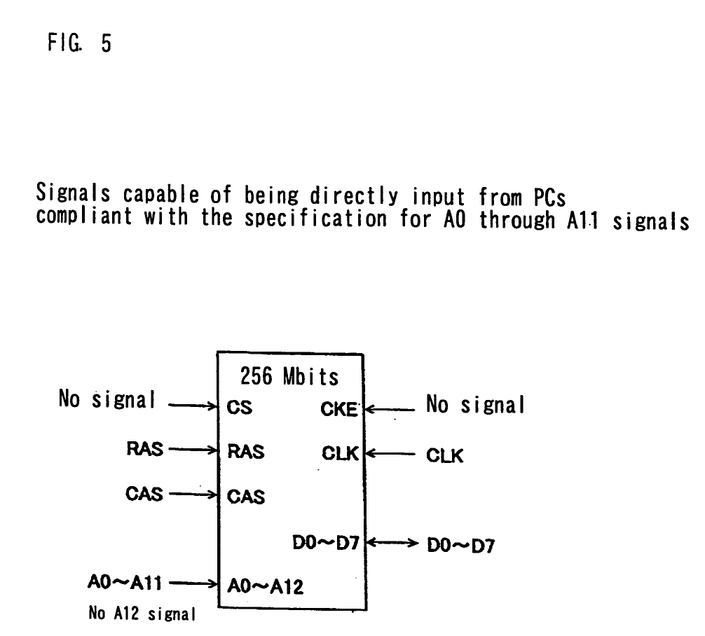

In recent years, there is a trend of using a 256-Mbyte DIMM comprising eight 256-Mbit SDRAMs. FIG. 5 partially shows 256-Mbit SDRAM terminals used for the desktop PC and signal lines connectable to the terminals.

The 256-Mbit SDRAM is supplied with a memory select signal and address signals A0 through A12 more than the second specified number of address signals A0 through A11. When the memory select signal goes L (selected), the 256-Mbit SDRAM enables access to data corresponding to the A0 through A12 signals. The 256-Mbit SDRAM can operate based on the CLK signal when the memory clock enable signal is input to the CKE terminal and the memory clock enable signal goes H (enabled).

As shown in FIG. 5, there are available signals corresponding to the CLK, RAS, CAS, and D0 through D7 terminals. The signals can be directly input to these terminals. With respect to the address signal input terminals, however, a signal corresponding to the A12 terminal always remains the voltage level L (unused as specified). It is only possible to access the 128-Mbit area that is half the memory capacity. No signals directly correspond to the CS and CKE terminals. When the CS0 and CSK0 signals or the CS1 and CSK1 signals are input, only the 128-Mbit area can be accessed after all. If the computer only outputs the A0 through A11 address signals, it can only handle a half of the 256-Mbit SDRAM area.

Using a memory circuit to be described, the memory module 10 generates an A12 address signal (additional address signal) higher than the A0 through A11 signals. The computer can access a memory area that cannot be accessed only through the use of the A0 through A11 signals.

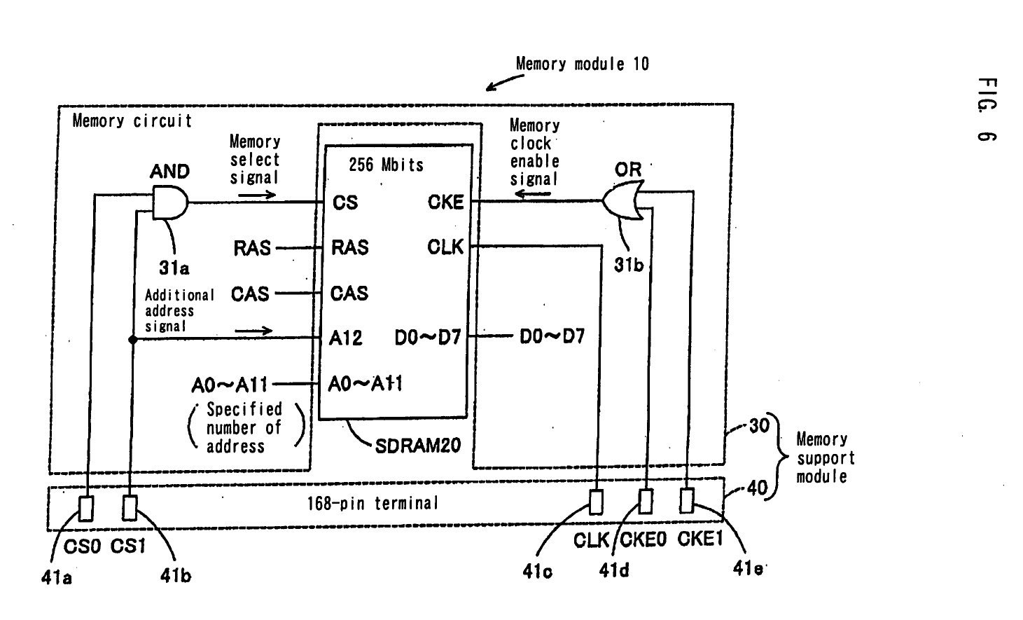

FIG. 6 is a partial circuit diagram of the memory module 10. The 256-Mbit SDRAM 20 in FIG. 6 represents one of eight SDRAMs 20 (e.g., the SDRAM at the left end) in FIG. 1. Actually, the similar circuit is formed for all the eight SDRAMs 20. As an only exception, each SDRAM 20 uses different types of data signal lines connected to the D0 through D7 terminals. The remaining terminals are connected to the same data signal lines. For ease of understanding, only input/output signal names are assigned to the RAS, CAS, A0 through A11, and D0 through D7 terminals. Actually, the signal lines for these signals are connected to the 168-pin terminal 40.

In FIG. 6, a memory support module 12 comprises a memory circuit 30 and the terminal 40. The memory circuit 30 has an AND gate 31a and an OR gate 31b. The gates 31a and 31b are provided in a gate IC 31.

Two input terminals of the AND gate 31a are connected to a CS0 terminal 41a and a CS1 terminal 41b in the terminal 40, respectively. An output terminal of the AND gate 31a is connected to a CS terminal of the SDRAM 20. A logical product results from the CS0 and CS1 signals as select signals for the 128-Mbit SDRAM and is supplied as a memory select signal CS to the CS terminal of the 256-Mbit SDRAM 20. When either of the input signals CS0 and CS1 is L (to select the memory space of the 128-Mbit virtual memory), the memory module 10 sets the memory select signal CS to L (to select the 256-Mbit SDRAM) When the input signals CS0 and CS1 are all set to H (to deselect the memory space of the 128-Mbit virtual memory), the memory module 10 sets the CS signal to H (to deselect the 256-Mbit SDRAM) The circuit enables input of a plurality of select signals and can appropriately generate a memory select signal based on the input select signals.

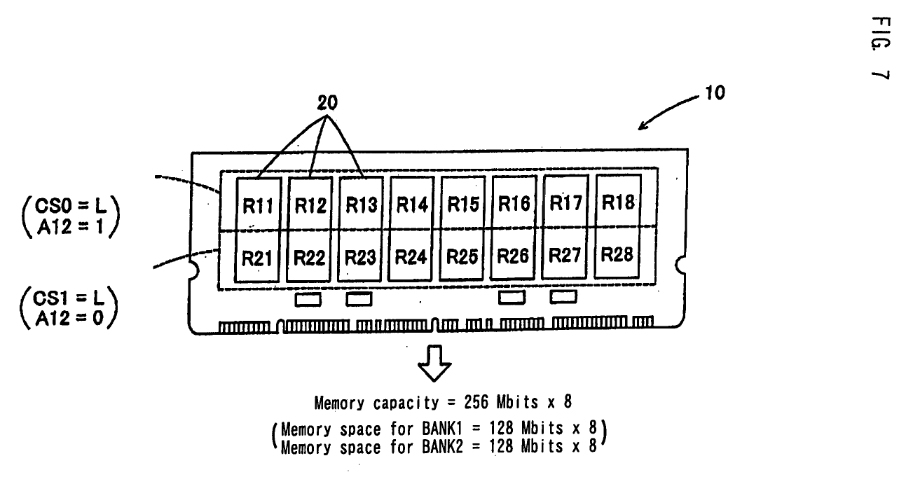

The CS1 signal is connected to the A12 terminal of the SDRAM 20. When the CS1 signal is L, the A12 signal input from the A12 terminal is set to “0”. When the CS0 signal is L, the CS1 signal becomes H and the A12 signal input from the A12 terminal is set to “1”. The circuit enables input of a plurality of select signals. Based on the input select signals, it is possible to generate an additional address signal A12 added to the second specified number of address signals A0 through A11 by using a simple structure. The additional address signal A12 is configured to be capable of representing addresses higher than the addresses represented by the A0 through A11 signals. Consequently, as shown in FIG. 7, a half of the memory areas for the 256-Mbit SDRAM 20 is allocated to the CWS0 signal set to L, i.e., BANK1. The remaining half of the memory areas is allocated to the CWS1 signal set to L, i.e., BANK2. The same reference numeral is given to the memory areas correspondingly allocated to the above-mentioned virtual memories R11 through R18 and R21 through R28. As shown in FIG. 7, it can be understood that the same 256-Mbit SDRAM 20 at the left end contains the virtual memory R11 allocated to BANK1 and the virtual memory R21 allocated to BANK2. In this manner, memory areas of the same SDRAM can be used properly in accordance with the select signal. It becomes possible to handle the memory module as a 2-bank memory module that virtually uses the 128-Mbit SDRAM.

When an A12 signal is generated from the two types of select signals CS0 and CS1 and is input to the A12 terminal, it may be preferable to input the CS0 signal instead of the CS0 signal to the A12 terminal.

In this manner, the desktop PC supplies the memory circuit 30 with the second specified number of address signals A0 through A11 and the select signals CS0 and CS1. The memory circuit 30 generates the memory select signal CS and the additional address signal A12. The memory circuit 30 supplies the 256-Mbit SDRAM 20 with the CS signal, the additional address signal A12, and the second specified number of address signals A0 through A11. The memory circuit 30 enables the desktop PC to access corresponding data.

Some desktop PCs generate a plurality of clock enable signals to sleep an unused bank of the 128-Mbit SDRAM. In such case, the memory circuit 30 is supplied with the CLK signal and the clock enable signals CKE0 and CKE1 from the desktop PC. Based on the input clock enable signals CKE0 and CKE1, the memory circuit 30 generates the memory clock enable signal CKE and supplies it as well as the CLK signal to the SDRAM 20.

The CLK terminal of the SDRAM 20 connects with a CLK terminal 41c in the terminal 40. Accordingly, the memory circuit 30 is configured to accept the CLK signal from the desktop PC and supply it to the SDRAM 20.

Two input terminals of an OR gate 31b connect with a CKE0 terminal 41d and a CKE1 terminal 41e in the terminal 40, respectively. An output terminal of the OR gate 31b connects with the CKE terminal of the SDRAM 20. A logical sum results from the CKE0 and CKE1 signals for the 128-Mbit SDRAM and is supplied as a CKE signal to the CKE terminal of the 256-Mbit SDRAM 20. When either of the input signals CKE0 and CKE1 is H (to enable clock signal input to the memory space of the 128-Mbit virtual memory), the memory module 10 sets the CKE signal to H (to enable clock signal input to the 256-Mbit SDRAM). When the input signals CKE0 and CKE1 are all set to L (to disable clock signal input to the memory space of the 128-Mbit virtual memory), the memory module 10 sets the CKE signal to L (to disable clock signal input to the 256-Mbit SDRAM).

### (2) Effects of the Memory Module

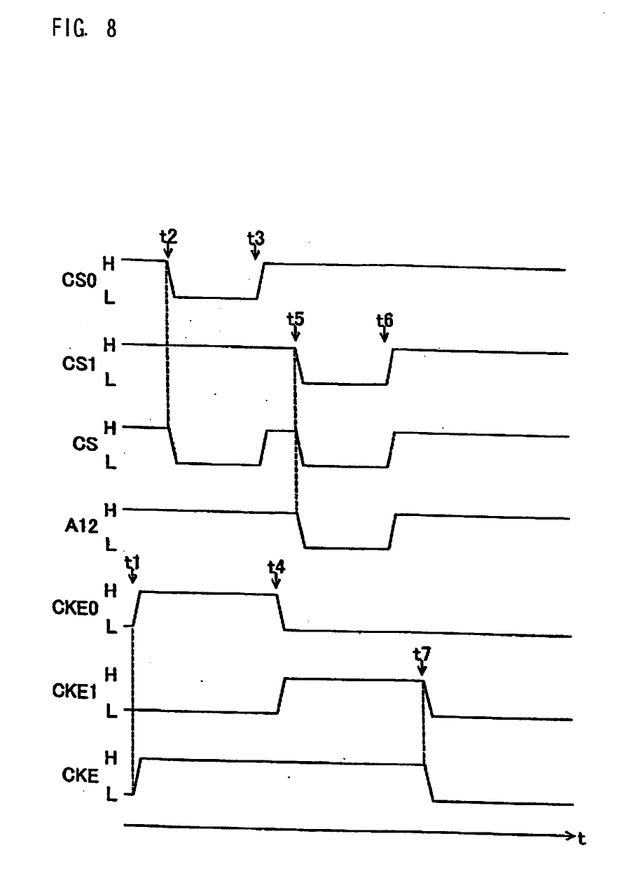

The following describes effects of the memory module 10 with reference to the timing chart in FIG. 8. The timings t1 through t7 are the same as those in FIG. 4.

The CKE0 signal rises from L to H (timing t1) to wake up BANK1 of the virtual memory. Since the H state is input to one of the input terminals of the OR gate 31b, this gate outputs the CKE signal set to H (enabled). The CKE0 signal falls from H to L and the CKE1 signal rises from L to H (timing t4) to wake up BANK2 of the virtual memory. At this time, the H state is input to one of the input terminals of the OR gate 31b. As a result, the OR gate 31b outputs the CKE signal set to H (enabled). On the other hand, the CKE1 signal falls from H to L (timing t7) to sleep both BANK1 and BANK2 of the virtual memory. Since the L state is input to both input terminals of the OR gate 31b, this gate outputs the CKE signal set to L (disabled)

Only when the 256-Mbit SDRAM 20 allows both BANK1 and BANK2 of the virtual memory to sleep, the L state is input to the CKE terminal and the CLK signal input is disabled. When either BANK1 or BANK2 of the virtual memory wakes up, the H state is input to the CKE terminal and the CLK signal input is enabled. The 256-Mbit SDRAM 20.operates based on the input CLK signal.

When the desktop PC outputs a plurality of clock enable signals to a plurality of memory spaces of the 128-Mbit virtual memory, the 256-Mbit SDRAM can be made accessible properly.

When the CKE0 signal is H, the CS0 signal falls from H to L (timing t2) to enable access to BANK1 of the virtual memory. Since the L state is input to one of the input terminals of the AND gate 31a, this gate outputs the CS signal set to L (selected state). Since the CS1 signal is set to H at this time, the A12 signal is set to H equivalent to 1. The H state is input to the A12 terminal of the SDRAM 20.

When the CKE1 signal is H, the CS1 signal falls from H to L (timing t5) to enable access to BANK2 of the virtual memory. Since the L state is input to one of the input terminals of the AND gate 31a, this gate outputs the CS signal set to L (selected state). Since the CS1 signal is set to L at this time, the A12 signal is set to L equivalent to 0. The L state is input to the A12 terminal of the SDRAM 20.

When the desktop PC makes access to both BANK1 and BANK2 of the virtual memory in the 256-Mbit SDRAM, the L state is input to the CS terminal. The 256-Mbit SDRAM can be made accessible from the desktop PC.

When an access is made to BANK1 of the virtual memory, the A12 signal goes to 1. When an access is made to BANK2 of the virtual memory, the A12 signal goes to 0. The desktop PC can access 256 Mbits of data corresponding to the additional address signal A12 and the second specified number of address signals A0 through A11.

Conventionally, the 256-Mbit memory may only allow 128-Mbit memory areas to be accessed by using only the second specified number of address signals A0 through A11 input from the computer. By contrast, the present invention generates the additional address signal A12 other than the A0 through A11 signals based on the select signal. The computer can access conventionally inaccessible memory areas. The memory areas can be used effectively. As a result, the computer can access the memory module using the 256-Mbit SDRAM as if it were a 2-bank memory module using 128-Mbit SDRAMs. Presently, 256-Mbit SDRAMs are regarded as mainstream, making availability of 128-Mbit SDRAMs difficult. The present invention makes it possible to effectively use memory modules composed of 256-Mbit SDRAM even on computers other than latest ones.

The plurality of select signals CS0 and CS1 generate the memory select signal CS, making it possible to increase the number of memories accessible from the computer. It is possible to ensure a large memory capacity the computer can handle.

### (3) Modification Examples

The memory module according to the present invention may be embodied in various modification examples.

While the above-mentioned memory module 10 represents DIMMs having no ECC (Error Correction Code), the present invention can be applied to memory modules with ECC simply requiring an addition of ECC memory. Of course, the present invention can be applied to not only DIMMs, but also SIMMs and the like.

Some SDRAMs use 16 data signal input/output terminals. The present invention can be applied even to such memories to effectively use memory areas. In this case, the memory needs to be able to accept a plurality of address signals more than the second specified number of address signals generated by the computer. Of course, the present invention can be applied to memories that do not use eight or 16 data signal input/output terminals. Further, the present invention can be applied to ROMs and the like that can only read data.

Moreover, the present invention can be applied to computers that can handle up to 128 Mbits of memory by using only the second specified number of address signals. When the present invention is applied to a computer that can handle up to 64 Mbits of memory, the computer becomes possible to handle 128 Mbits of memory. As will be described later, it is possible to handle memories having the memory capacity of 256 Mbits or more. When the present invention is applied to a computer that can handle up to 256 Mbits of memory, the computer becomes possible to handle memories having the memory capacity of 512 Mbits or more.

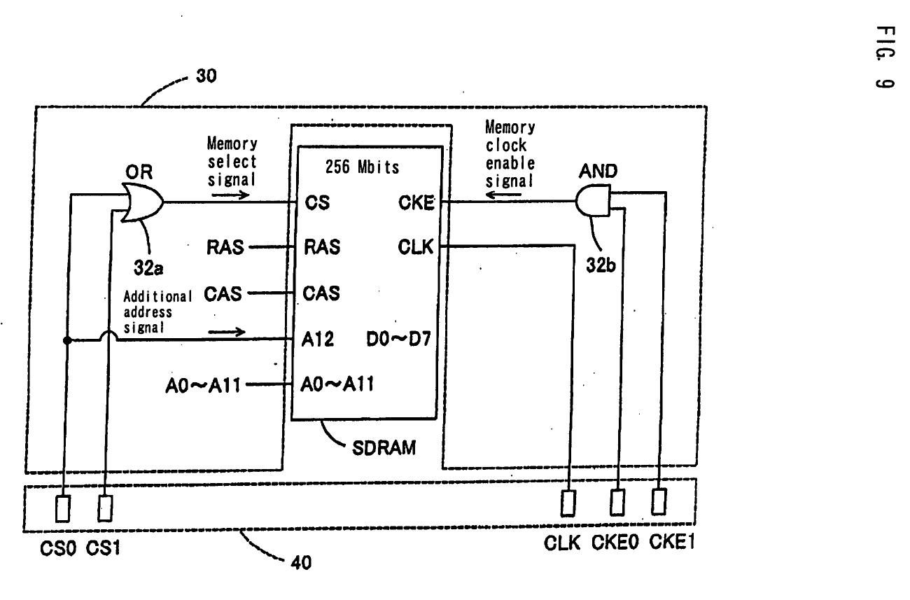

When the select signal and the memory select signal operate in positive logic, it is preferable to use the OR gate 32a instead of the AND gate 31a as shown in FIG. 9. In this case, when any one of the CS0 and CS1 signals is set to H (selected), the memory select signal CS is set to H (selected) to enable access to the SDRAM.

When the select signal and the memory select signal operate in negative logic, it is preferable to use the AND gate 32b instead of the OR gate 31b as shown in FIG. 9. In this case, when any one of the CKE0 and CKE1 signals is set to L (enabled), the CKE signal is set to L (enabled). This enables the SDRAM to operate based on the CLK signal.

Furthermore, the memory module according to the present invention can operate without supplying the memory select signal to memories mounted on the memory module. The computer may generate two types of select signals respectively for two memory spaces having capacities corresponding to the second specified number of address signals. In this case, it maybe preferable to always select the CS terminal of the mounted memory. Of course, the memory just needs to be able to input address signals more than the second specified number of address signals and access corresponding data. The CS terminal may not be provided.

In this case, the memory circuit just needs to enable the computer to access corresponding data as follows. The memory circuit is supplied with the second specified number of address signals and the select signal from the computer. Based on the input select signal, the memory circuit generates an additional address signal added to the second specified number of address signals. The memory circuit supplies the additional address signal and the second specified number of input address signals to the memory. The above-mentioned example supplies the memory with any one of two types of select signals supplied from the computer as the additional address signal. Memory areas of the same SDRAM can be used properly in accordance with the select signal. The memory areas can be used effectively.

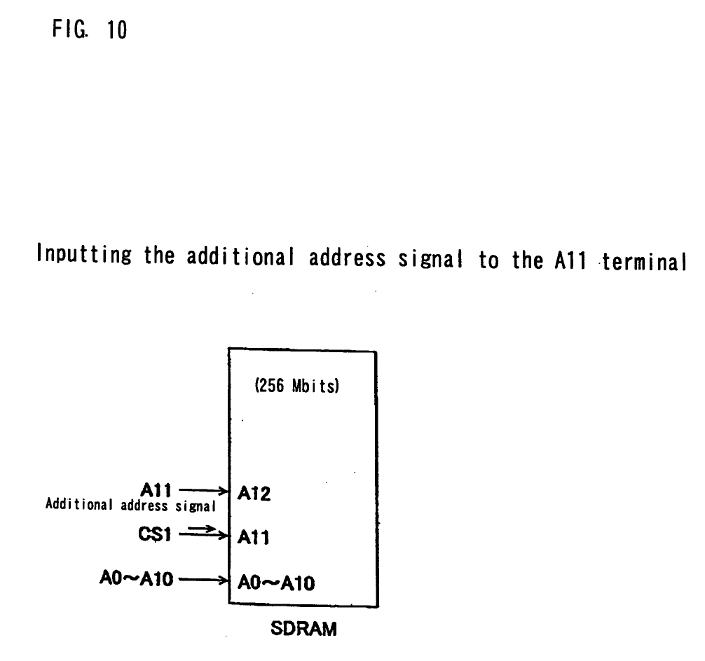

The additional address signal is not limited to an address signal to represent the highest-order address that can be input to the memory. FIG. 10 is a block diagram partially showing signals input to a 256-Mbit SDRAM mounted on the memory module according to another modification example. It is assumed that the A11 and A12 terminals are only used for row address input, not for column address input. In this case, the A0 through A10 signals input from the terminals may be input to the A0 through A10 terminals of the 256-Mbit SDRAM. The A11 signal may be input to the A12 terminal of the 256-Mbit SDRAM. The CS1 signal may be input as the additional address signal to the A11 terminal. On the other hand, it is assumed that the SDRAM's A10 through A12 terminals are used for row address input only. In this case, A0 through A9 signals supplied from the 168-pin terminal may be input to the SDRAM's A0 through A9 terminals. The A10 and A11 signals may be input to the SDRAM's A11 and A12 terminals, respectively. The CS1 signal may be input as the additional address signal to the A10 terminal. When the A0 terminal is used for row address input only, the CS1 signal supplied from the 168-pin terminal may be input as the additional address signal to the A0 terminal.

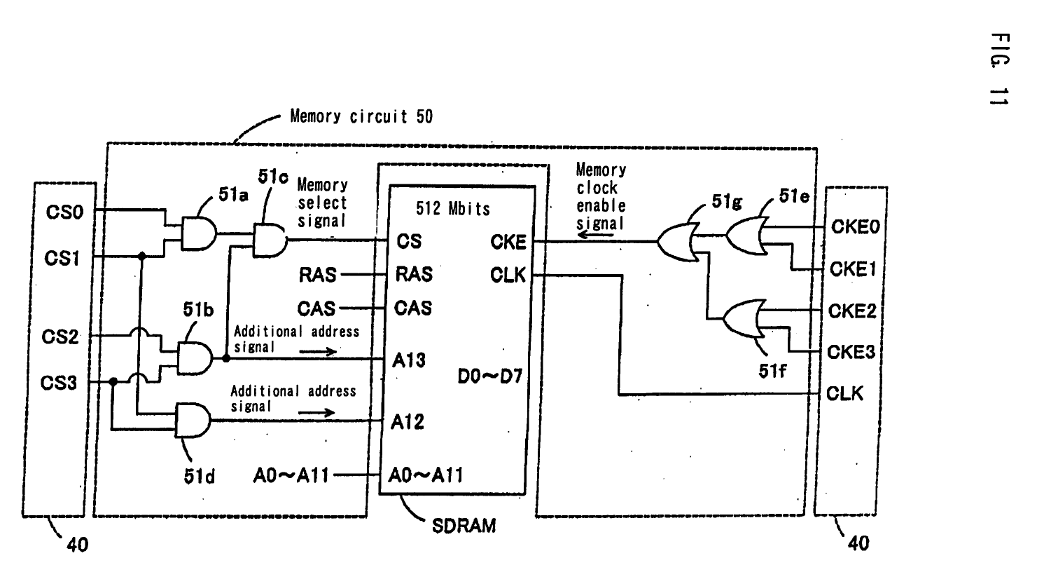

A plurality of additional address signals may be generated from three types or more of select signals to select three banks or more. FIG. 11 is a partial circuit diagram of the memory module circuit according to another modification example.

The memory module is a 512-Mbyte DIMM comprising eight 512-Mbit SDRAMs. The 512-Mbit SDRAM is capable of accepting 14 types of address signals A0 through A13, i.e., two signals more than the second specified number of address signals A0 through A11 supplied from the desktop PC. Another two address signals are needed to access all memory areas of the SDRAM. The 512-Mbit SDRAM in FIG. 11 represents one of eight SDRAMs.

The following describes an example in which the desktop PC handles a memory capacity of 512 Mbytes as four 128-Mbyte banks.

In FIG. 11, a memory circuit 50 comprises AND gates 51a through d and OR gates 51e through 51g.

Two input terminals of the AND gate 51a connect with the CS0 and CS1 terminals in the 168-pin terminal 40. Two input terminals of the AND gate 51b connect with the CS2 and CS3 terminals in the 168-pin terminal 40. Two input terminals of the AND gate 51c connect with output terminals of the AND gates 51a and 51b, respectively. An output terminal of the AND gate 51c connects with the CS terminal of the SDRAM. When any of the input select signals CS0 through CS3 is L (to select the memory space of the 128-Mbit virtual memory), the memory module 10 sets the memory select signal CS to L (to select the 512-Mbit SDRAM). When the input signals CS0 and CS3 are all set to H (to deselect the memory space of the 128-Mbit virtual memory), the memory module 10 sets the CS signal to H (to deselect the 512-Mbit SDRAM).

An A13 terminal of the SDRAM connects with an output terminal of the AND gate 51b. Two input terminals of the AND gate 51d connect with CS1 and CS3 terminals in the terminal 40, respectively. The A12 terminal of the SDRAM connects with an output terminal of the AND gate 51c.

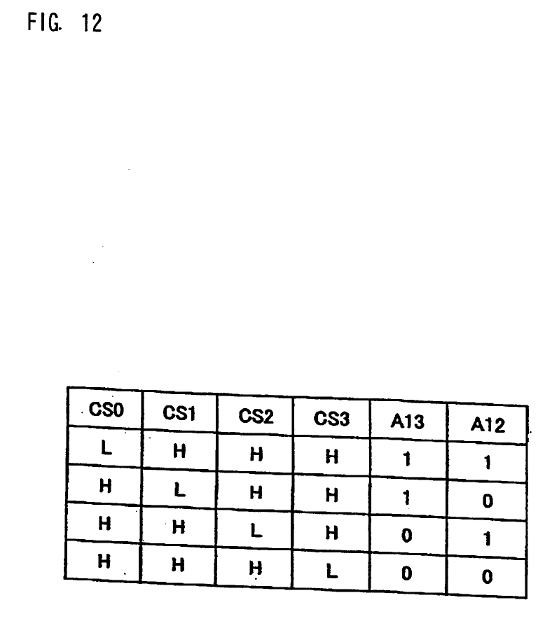

As shown in FIG. 12, when the CS0 through CS3 signals are set to 0, 1, 1, and 1, respectively, the A13 and A12 signals are set to 1 and 1, respectively. When the CS0 through CS3 signals are set to 1, 0, 1, and 1, respectively, the A13 and A12 signals are set to 1 and 0, respectively. When the CS0 through CS3 signals are set to 1, 1, 0, and 1, respectively, the A13 and A12 signals are set to 0 and 1, respectively. When the CS0 through CS3 signals are set to 1, 1, 1, and 0, respectively, the A13 and A12 signals are set to 0 and 0, respectively. In this manner, the combination of the A13 and A12 signals varies with any of the CS0 through CS3 signals that becomes L. When supplied with a plurality of select signals, the memory circuit can generate the additional address signals A12 and A13 added to the second specified number of address signals A0 through A11 based on the input select signals. As a result, a quarter of memory areas for the 512-Mbit SDRAM 20 is allocated to any of the CS0 through CS3 signals set to L, i.e., BANK1 through BANK4.

When the A13 signal is generated and is input to the A13 terminal, it may be preferable to input a logical product of the CS0 and CS1 signals instead of a logical product of the CS2 and CS3 signals. When the A12 signal is generated and is input to the A12 terminal, it maybe preferable to input a logical product of the CS0 and CS2 signals instead of a logical product of the CS1 and CS3 signals.

According to this configuration, the memory circuit 50 enables the desktop PC to access corresponding data in all memory areas as follows. The memory circuit 50 is supplied with the second specified number of address signals A0 through A11 and the select signals CS0 through CS3 from the desktop PC. The memory circuit 50 generates the memory select signal CS and the additional address signals A12 and A13. The memory circuit 50 supplies the 512-Mbit SDRAM with the CS signal, the additional address signals A12 and A13, and the second specified number of address signals A0 through A11.

Two input terminals of the OR gate 51e connect with the CKE0 and CKE1 terminals in the terminal 40, respectively. Two input terminals of the OR gate 51f connect with the CKE2 and CKE3 terminals in the terminal 40, respectively. Two input terminals of the OR gate 51g connect with output terminals of the OR gates 51e and 51f, respectively. An output terminal of the OR gate 51g connects with the SDRAM's CKE terminal. When any of the input signals CKE0 through CKE3 is H (to enable clock signal input to the memory space of the 128-Mbit virtual memory), the memory module 10 sets the memory clock enable signal CKE to H (to enable clock signal input to the 512-Mbit SDRAM). When the input signals CKE0 through CKE1 are all set to L (to disable clock signal input to the memory space of the 128-Mbit virtual memory), the memory module 10 sets the CKE signal to L (to disable clock signal input to the 512-Mbit SDRAM). Consequently, when the desktop PC outputs a plurality of clock enable signals to a plurality of memory spaces of the 128-Mbit virtual memory, the 512-Mbit SDRAM can be made accessible properly.

When the computer handles three 128-Mbyte banks at a time, the CS3 and the CKE3 signals are not input to the memory module. Using the circuit in FIG. 11, however, it becomes possible to use memory areas equivalent to 384 Mbits (128×3) out of the 512-Mbit SDRAM. In this case, all memory areas of the 512-Mbit SDRAM are not used. However, the computer can handle a wider area than the 128-Mbit memory areas that are accessible only through the use of the second specified number of address signals A0 through A11. It is still possible to effectively use memory areas of the 512-Mbit SDRAM.

The present invention can be also applied to a memory module mounted with a 1-gigabit (Gbit) SDRAM capable of accepting A0 through A14 signals. In this case, the computer needs to be able to generate the second specified number of address signals A0 through A11 and eight types of select signals CS0 through CS7. The memory circuit enables the desktop PC to access corresponding data in all memory areas as follows. The memory circuit accepts the A0 through A11 signals and the CS0 through CS7 signals from the computer. The memory circuit generates the memory select signal CS and the additional address signals A12 through A14. The memory circuit supplies the 1-Gbit SDRAM with the CS signal, the additional address signals A12 through A14, and the second specified number of address signals A0 through A11. Further, the memory circuit can generate the memory clock enable signal CKE by accepting eight types of clock enable signals CKE0 through CKE7.

Even if a memory module is not mounted with memories, mounting memories enables the computer to access a memory area that cannot be accessed only through the use of the second specified number of address signals. Accordingly, the present invention is also effective for the memory support module 12, namely, the memory module 10 void of the SDRAM 20 as shown in FIG. 6. Of course, the memory support module may be provided with a memory socket to attach a memory or may be shaped to be able to solder a memory.

### (4) Configuration of a Memory Module According to a Second Embodiment

When the computer does not comply with the capacity of mounted memory chips, the first embodiment can virtually scale down the capacity of memory chips mounted on the memory circuit. As a result, the first embodiment enables the computer to access a memory area that cannot be accessed only by using the second specified number of address signals supplied from the computer while all memory areas cannot be accesses only through such address signals depending on memory chips. An advantage of the first embodiment is capability of effectively using memory areas. However, a latest computer may generate the A12 signal, i.e., a high-order address signal that indicates an address higher than addresses indicated by the second specified number of address signals. The first embodiment ignores the A12 signal from the computer. It is impossible to connect the memory module as is. In consideration for this, a second embodiment provides a memory module connectable to latest computers that can access more memory areas, as will be described below.

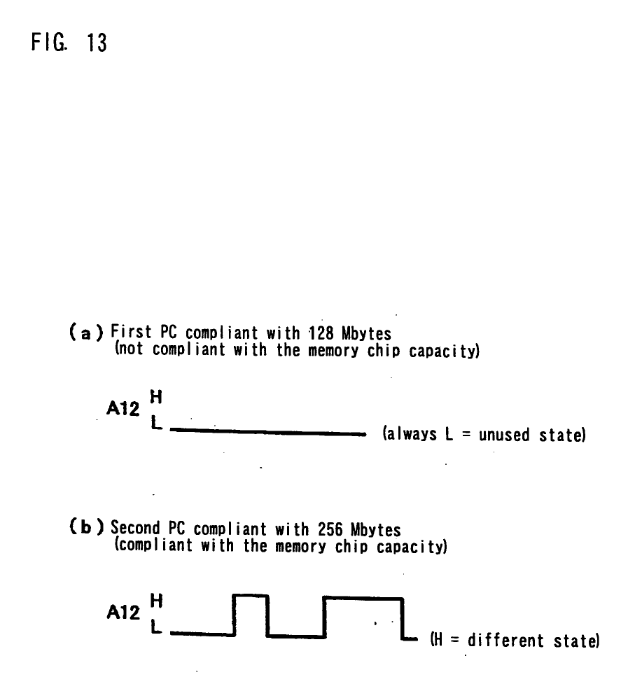

When a first PC (first computer) is compliant with 128 Mbytes, the high-order address signal A12 becomes higher than the second specified number of address signals A0 through A11. The voltage level is always set to L (unused as specified) as shown in FIG. 13. On the other hand, when a second PC (second computer) is compliant with 256 Mbytes, the A12 signal is included in a specified number of address signals A0 through A12 more than the second specified number of address signals. The voltage level becomes H (not unused state) or L as needed. In consideration for this, it is determined whether or not the A12 signal becomes H. In this manner, it is determined whether or not the computer complies with the capacity of mounted memory chips to determine an operation of the memory circuit.

The second PC generates a clock signal CLK, a select signal CS0, a CKE0 signal, and the like. The select signal CS0 indicates the selected or unselected state of the memory space having the capacity corresponding to the A0 through A12 signals. The CKE0 signal indicates the enabled or disabled state of the memory space having the capacity corresponding to the A0 through A12 signals.

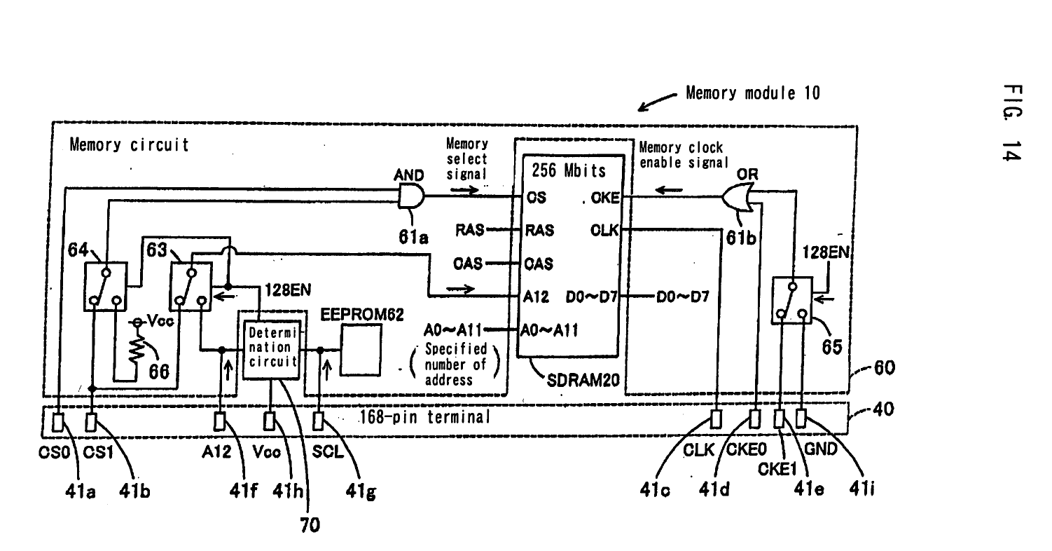

FIG. 14 is a partial circuit diagram of a memory module circuit according to the second embodiment. The mutually corresponding parts in the second and first embodiments are designated by the same reference numerals and a detailed description is omitted. A memory module 110 has an SDRAM 20, a memory circuit 60, and a determination circuit 70, and is provided with the 168-pin terminal 40. The memory support module comprises the memory circuit 60, the determination circuit 70, and the terminal 40.

Then memory circuit 60 has not only an AND gate 61a and an OR gate 61b, but also EEPROM 62, switch circuits 63 through 65 provided in a general-purpose switch IC, and a resistor device 66. Each of the switch circuits 63 through 65 has two input sections and one output section as terminals, and a selection signal input section. The switch circuit electrically connects only one of the input sections to the output section depending on voltage level H or L of a signal input to the selection signal input section.

Two input sections of the first switch circuit 63 connect with a CS1 terminal 41b and an A12 terminal 41f in the terminal 40, respectively. Two input sections of the second switch circuit 64 connect with the CS1 terminal 41b and one end of the resistor device 66, respectively. The other end of the resistor device 66 is connected to power supply line Vcc (a Vcc terminal 41h in the terminal 40). Two input sections of the third switch circuit 65 connect with the CKE1 terminal 41e in the terminal 40 and a ground (a GND terminal 41i in the terminal 40), respectively. A 128EN signal from the determination circuit 70 is input to the selection signal input sections of the switch circuits 63 through 65.

Two input terminals of the AND gate 61a connect with the CS0 terminal 41a in the terminal 40 and an output section of the second switch circuit 64, respectively. An output terminal of the AND gate 61a connects with the CS terminal of the SDRAM 20. The A12 terminal of the SDRAM 20 connects with the output section of the first switch circuit 63. Two input terminals of the OR gate 61b connect with the CKE0 terminal 41d in the terminal 40 and the output section of the third switch circuit 65, respectively. The output terminal of the OR gate 61b connects with the CKE terminal of the SDRAM 20.

The EEPROM 62 is nonvolatile memory to realize a plug-and-play function as a specified standard. The EEPROM 62 comprises an EEPROM array, an address decoder, a data register, a control circuit, and the like. The EEPROM 62 stores data to be read before access to the memory chip. The EEPROM 62 is an IC chip having a specified number of terminals accessible via an IIC bus. A serial clock input terminal SCL connects with an SCL terminal 41g in the terminal 40. A serial data input/output terminal SDA connects with an SDA terminal in the terminal 40. Based on a serial clock input from the SCL terminal, the PC controls input/output of serial data from the SDA terminal or controls data reading or writing to the EEPROM array. When an ID is read from the EEPROM, the PC can identify the specification of expanded memory. The PC can optimally access the memory module's SDRAM thereafter.

The determination circuit 70 is connected to the A12 terminal 41f, the SCL terminal 41g, the Vcc terminal 41h, the GND terminal 41i, and the like. The determination circuit is supplied with the A12 signal, an SCL signal, a Vcc potential, and a GND potential, and generates a 256EN signal and a 128EN signal that is an inverse of the 256EN signal.

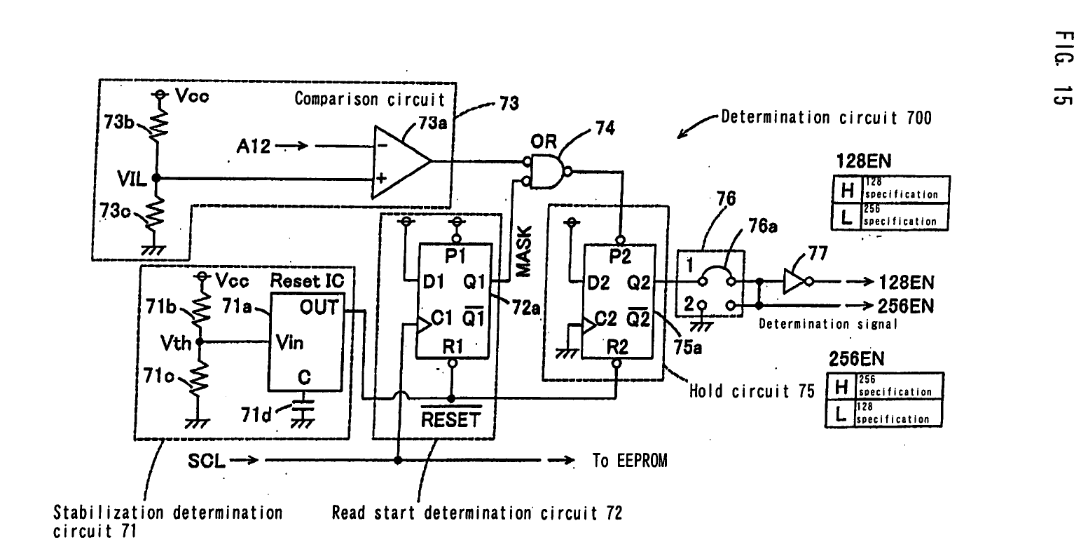

As shown in FIG. 15, the determination circuit 70 comprises circuits 71 through 77.

A stabilization determination circuit 71 comprises a resistor device 71b (Vcc side) and a resistor device 71c (GND side) that are serially connected between the power supply line Vcc and the ground. Assuming that the resistor devices 71b and 71c are given resistance values R1 and R2, respectively, potential Vth is divided into R2/(R1+R2) at an intermediate junction. A general-purpose reset IC 71a has a Vin terminal connected to the intermediate junction of the resistor devices 71b and 71c. A C terminal connects with one end of a capacitor 71d whose the other end is connected to GND. The reset IC 71a determines whether or not the potential Vth is smaller than or equal to a specified threshold potential (e.g., smaller than or equal to 3.3 V). The reset IC 71a then generates a reset signal and outputs it from an output terminal OUT. The reset signal indicates an on-state when the potential Vth is determined to be smaller than the threshold potential. Otherwise, the reset signal indicates an off-state. In the following description of this embodiment, a negative-logic reset signal RESET is generated to indicate voltage level L when Vth is determined to be smaller than the threshold potential. Alternatively, the RESET signal is generated to indicate voltage level H when Vth is determined to be larger than the threshold potential.

A read start determination circuit 72 is provided for a general-purpose flip-flop IC, for example. The read start determination circuit 72 comprises a D-FF (D flip-flop) 72a capable of R-S-FF (reset flip-flop) operations. In the FF 72a, a preset terminal P1 and an input terminal D1 are connected to Vcc. A reset terminal R1 is connected to an OUT terminal of the reset IC 71a. An SCL signal is input to a clock signal input terminal C1. An output terminal Q1 is connected to one input terminal of a dual input OR gate 74 (gate circuit for logical sum). When the R1 terminal is L (on-state), the FF72a is reset. Independently of voltage level states of the input terminals D1 and C1, an on-state mask signal MASK is generated and is output from a Q1 terminal. In the following description of the embodiment, the MASK signal is assumed to operate in positive logic and indicate an on-state when set to H or an off-state when set to L. When the R1 terminal is set to H (off-state), the FF 72a is released from the reset state. The output terminal Q1 is set to a voltage level corresponding to that of the D1 terminal when the SCL signal falls from H to L. In the following description of the embodiment, it is assumed that lowering the SCL signal generates an L-state MASK signal by inverting the voltage level of the D1 terminal and that the MASK signal is output from the Q1 terminal.

Data is read from the EEPROM before access to a memory chip. To read data from the EEPROM, a pulse-shaped SCL signal needs to be supplied. Accordingly, the circuit 72 determines whether or not data starts to be read from the EEPROM when the reset signal changes from the on-state to the off-state and keeps the off-state. The circuit 72 generates an on-state mask signal when determining that readout of the data does not start. The circuit 72 generates an off-state mask signal when determining that readout of the data starts.

A comparison circuit 73 comprises a resistor device 73b (Vcc side) and a resistor device 73c (GND side) that are serially connected between Vcc and GND. Assuming that the resistor devices 73b and 73c are given resistance values R3 and R4, respectively, potential VIL (specified second threshold potential) is divided into R4/(R3+R4) at an intermediate junction. A comparator 73a is a general-purpose IC and has a positive input terminal connecting with the intermediate junction for the resistor devices 73b and 73c, a negative terminal supplied with the A12 signal, and an output terminal connecting with one of input terminals of the dual input OR gate 74. The comparator 73a according to the embodiment inversely outputs the A12 signal. The comparator 73a compares the A12 signal potential with the second threshold potential VIL. When the A12 signal is L (unused state), the comparator 73a outputs a comparison result of a specified first potential (H in this embodiment). When the A12 signal is H (not unused state), the comparator 73a outputs a comparison result of a specified second potential (L in this embodiment).

The OR gate 74 is a circuit that outputs a logical sum of input signals. The OR gate 74 outputs a signal of specified third potential L when the above-mentioned comparison result shows the second potential L and the MASK signal is L (off-state). The OR gate 74 outputs a signal of specified fourth potential H when the above-mentioned comparison result shows the first potential H or the MASK signal is H (on-state).

A hold circuit 75 is provided for a general-purpose flip-flop IC, for example. The hold circuit 75 comprises a D-FF 75a capable of R-S-FF operations. In the FF 75a, a preset terminal P2 is connected to an output terminal of the OR gate 74. A reset terminal R2 is connected to an OUT terminal of the reset IC71a. An input terminal D2 is connected to Vcc. A clock signal input terminal C2 is connected to GND. An output terminal Q2 is connected to an input section of a switch circuit 76. Since the C2 terminal is connected to GND, the FF 75a functions as R-S-FF. When the P2 terminal is set to the fourth potential H, the FF 75a is released from the preset state. Correspondingly to the voltage level of the input terminal D2, the FF 75a generates and outputs a determination signal indicative of an unchanged state (L in this embodiment) from the Q2 terminal. When the P2 terminal is set to the third potential L, the FF 75a is preset. Correspondingly to the voltage level of the input terminal D2, the FF 75a generates, holds, and outputs a determination signal indicative of a changed state (H in this embodiment) from the Q2 terminal.

Only when the mask signal or the reset signal is set to the off-state, the circuits 73 through 75 determine whether or not the high-order address signal changes from the unused state to a different state. The circuits 73 through 75 function as state holding circuits to generate a determination signal indicative of the state corresponding to the determination result.

In the switch circuit 76, for example, when a jumper wire 76a is connected to “1”, the generated determination signal is assumed to be a 256EN signal. When the jumper wire 76a is connected to “2”, the 256EN signal is assumed to be L. An inverter 77 reverses the voltage level of the determination signal that is then assumed to be a 128EN signal. When the 256EN signal is set to H (128EN signal set to L), a determination signal is generated to indicate a state different from the unchanged state. This means that the PC mounted with the memory module 110 is configured to be 256-Mbyte specification (second PC) When the 256EN signal is set to L (128EN signal set to H), a determination signal is generated to indicate the unchanged state. This means that the PC mounted with the memory module 110 is configured to be 128-Mbyte specification (first PC). The embodiment outputs the 128EN signal, one type of determination signals, to the switch circuits 63 through 65 for the memory circuit to determine operations of the memory circuit 60.

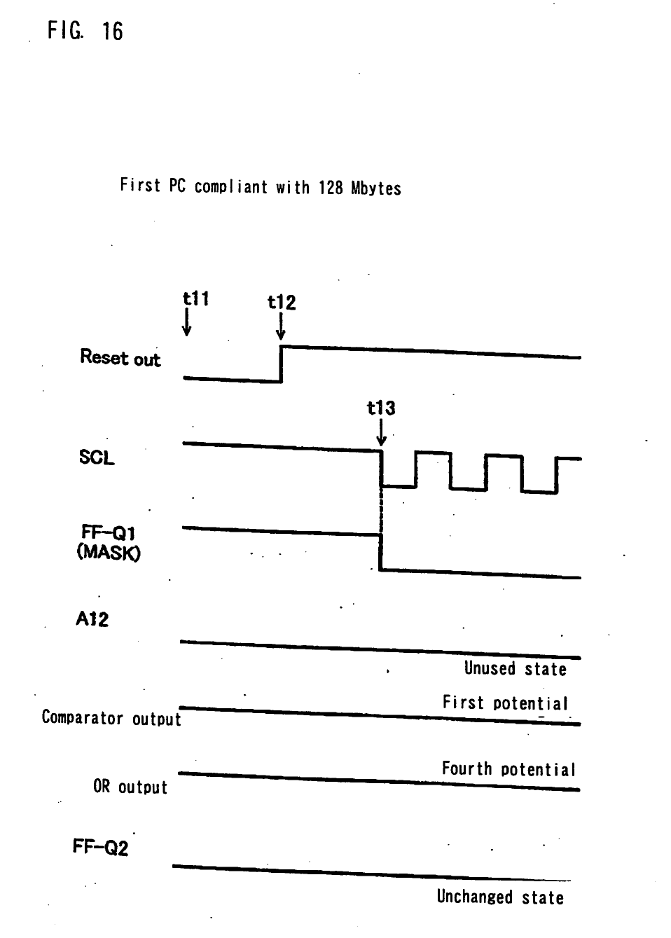

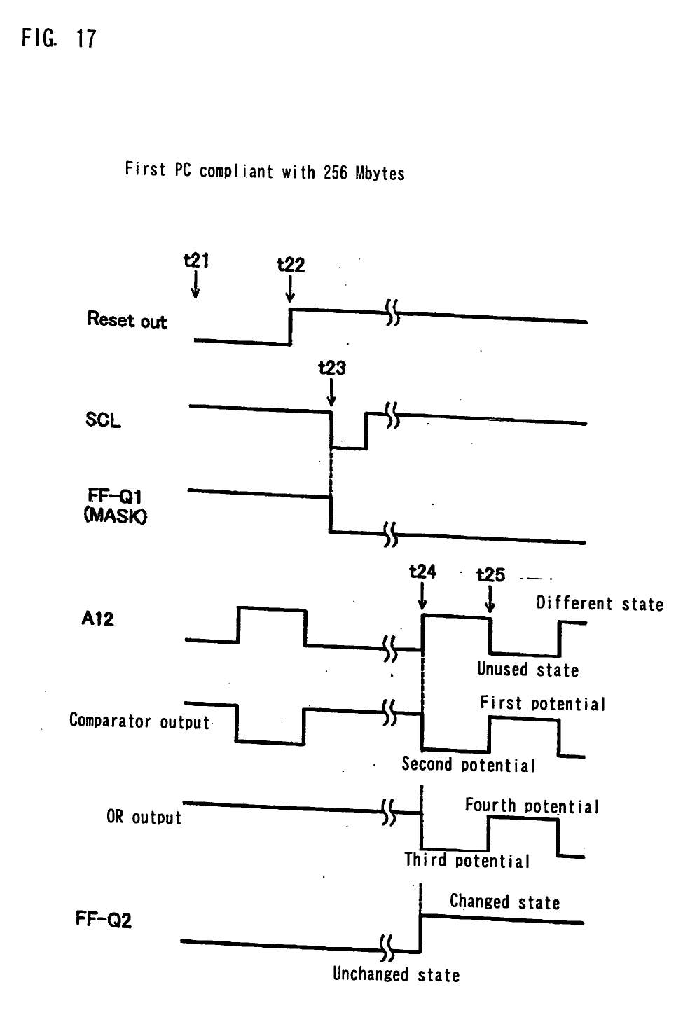

The following describes effects of the memory module 110 with reference to timing charts in FIGS. 16 and 17. In each timing chart, an upper side indicates voltage level H and a lower side indicates voltage level L. It is assumed that the SCL signal becomes H immediately after power-on and remains being H until data is read from the EEPROM.

FIG. 16 shows that the memory module is mounted on the first PC compliant with the 128-Mbyte specification. When the PC is turned on (timing t11), potential Vth remains below the specified threshold potential for a while. The reset IC 71a outputs the RESET signal set to L (on-state) from the OUT terminal. The FF 72a is supplied with the RESET signal and becomes reset. The Q1 terminal outputs the MASK signal set to H (on-state). An output from the OR gate 74 is set to the fourth potential H independently of a comparison result from the comparator 73a. The FF 75a is supplied with the fourth potential H at the P2 terminal and is released from the preset state. The Q2 terminal generates a determination signal set to L (unchanged state). This signal is output as a256EN signal. The inverted determination signal is output as a 128EN signal.

As a result, the switch circuit 63 determines connection to a signal line for the A12 signal of the SDRAM 20 to be a signal line for the high-order address signal (CS1 signal according to the embodiment) generated based on the select signal from the PC. The switch circuit 64 determines connection to a signal line for the CS signal of the SDRAM 20 to be a signal line for the memory select signal (CS1 signal according to the embodiment) generated based on the select signal from the PC. The switch circuit 65 determines connection to a signal line for the CKE signal of the SDRAM 20 to be a signal line for the memory clock enable signal (CKE1 signal according to the embodiment) generated based on the clock enable signal from the PC.

When the potential Vth becomes greater than or equal to the specified threshold potential (timing t12), the reset IC 71a outputs the RESET signal set to H (off-state) from the OUT terminal. The FF 72a is supplied with the RESET signal and is released from the reset state. While the SCL signal remains H, a voltage output from the Q1 terminal remains H. The Q1 terminal continues to output the MASK signal set to H (on-state). In this case, an output from the OR gate 74 remains the fourth potential H independently of the A12 signal state. A voltage output remains L (unchanged state) at the Q2 terminal of the FF 75a.

When the SCL signal changes from H to L thereafter (timing t13), the FF 72a outputs the MASK signal set to L (off-state) from the Q1 terminal. When the A12 signal is set L (unused state), however, an output from the comparator 73a remains the first potential H. The output from the OR gate 74 remains the fourth potential H. The FF 75a is supplied with the fourth potential at the P2 terminal and remains being released from the preset state. The Q2 terminal continues to generate the determination signal set to L (unselected state). The 256EN and 128EN signals remain unchanged.

The switch circuits 63 through 65 remain unchanged. The A12 terminal of the SDRAM 20 is supplied with the high-order address signal (CS1 signal) generated based on the select signal from the PC. The CS terminal of the SDRAM 20 is supplied with the memory select signal (CS1 signal) generated based on the select signal from the PC. The CKE terminal of the SDRAM 20 is supplied with the memory clock enable signal (CKE1 signal) generated based on the clock enable signal from the PC. This results in the same effect as the first embodiment. The PC is allowed to access a memory area that cannot be accessed only through the use of the A0 through A11 signals supplied from a PC compliant with the 128-Mbyte specification. It becomes possible to effectively use memory areas.

FIG. 17 shows that the memory module is mounted on the second PC compliant with the 256-Mbyte specification. When the PC is turned on (timing t21), potential Vth remains below the specified threshold potential for a while. The reset IC 71a outputs the RESET signal set to L (on-state) from the OUT terminal. The FF 72a is supplied with the RESET signal and outputs the MASK signal set to H (on-state) from the Q1 terminal. An output from the OR gate 74 is set to the fourth potential H independently of a comparison result from the comparator 73a. The FF 75a is supplied with the fourth potential H at the P2 terminal and generates the determination signal set to L (unchanged state) as a 256EN signal from the Q2 terminal. The inverted determination signal is output as a 128EN signal.

When the potential Vth becomes greater than or equal to the specified threshold potential (timing t22), the reset IC 71a outputs the RESET signal set to H (off-state) from the OUT terminal. While the SCL signal remains H, the FF 72a supplied with the RESET signal keeps the voltage level H output from the Q1 terminal. The Q1 terminal continues to output the MASK signal set to H (on-state). In this case, an output from the OR gate 74 remains the fourth potential H independently of the A12 signal state. A voltage output remains L (unchanged state) at the Q2 terminal of the FF 75a. It is determined whether or not the high-order address signal changes from the unused state to a different state only when the Vcc potential becomes greater than or equal to the specified threshold potential to stabilize the power supply voltage. It is possible to reliably prevent malfunctions to generate determination signals.

When the SCL signal changes from H to L thereafter (timing t23), the FF 72a outputs the MASK signal set to L (off-state) from the Q1 terminal. When the A12 signal is set L (unused state), an output from the comparator 73a remains the first potential H. It is determined whether or not the high-order address signal changes from the unused state to a different state after the power supply voltage stabilizes before access to the memory chip. It is possible to reliably prevent malfunctions to generate determination signals.

The PC compliant with the 256-Mbyte specification may set the A12 signal to H (timing t24). At this time, the comparator 73a outputs the second potential L. Since the OR gate 74 is supplied with the MASK signal set to L and the second potential L, the output changes to the third potential L. The F 75a is supplied with the third potential L at the P2 terminal and is set to the preset state. The determination signal set to H (unchanged state) is generated from the Q2 terminal and is held. The 256EN signal is set to H. The 128EN signal is set to L. Thereafter, the A12 signal may change to L to change an output from the comparator 73a to H (e.g., timing t25). Even in this case, a state holding function of the FF 75a holds the determination signal set to H.

In this manner, the determination circuit 70 determines operations of the memory circuit 60.

Consequently, the switch circuit 63 determines connection to the signal line for the A12 signal of the SDRAM 20 to be a signal line for the high-order address signal from the PC. The switch circuit 64 selects the input corresponding to the resistor device 66 to set the voltage level to H. As a result, the AND gate 61a transmits the CS0 signal as is from the PC to the CS terminal of the SDRAM 20. Accordingly, connection to the signal line for the CS signal of the SDRAM 20 is determined to be the signal line for the CS0 signal from the PC. The switch circuit 65 selects the input corresponding to GND to set the voltage level to L. As a result, the OR gate 61b transmits the CKE0 signal as is from the PC to the CKE terminal of the SDRAM 20. Accordingly, connection to the signal line for the CKE signal of the SDRAM 20 is determined to be the signal line for the CKE0 signal from the PC. That is to say, the A12, CS0, and CKE0 signals from the PC are input to the A12, CS, and CKE terminals of the SDRAM 20, respectively. It is possible to access data correspondingly to the capacity of mounted memory chips. Therefore, if connected to a PC compliant with the 256-Mbyte specification, the memory module enables access to memory areas of the capacity corresponding to all the input address signals.

As mentioned above, the memory module and the memory support module according to the present invention enable computers to access memory areas that cannot be accessed only through the use of address signals input from earlier model computers. The memory areas can be used effectively. The memory module can be also connected to latest computers that can access more memory areas, eliminating the need for memory modules specific to computer models.

Various modification examples are also available for the memory module according to the second embodiment.

The high-order address signal A12 may be set to H to indicate the unused state for the first and second PCs. In such case, the common memory module can be likewise connected, for example, by using the comparator to prevent the signal from being inverted.

A state different from the unused state may be determined by detecting whether the voltage level of the high-order address signal A12 changes from L to H or from H to L.

If both outputs from the comparator and the FF's Q1 terminal are inverted, a NAND or an AND gate can be used instead of the OR gate 74.

If an output from the FF's Q2 terminal is inverted, the 256EN signal is also available by generating a determination signal that is set to H to indicate the unused state or is set to L to indicate the changed state.

The read start determination circuit 72 may be omissible. In this case, the FF 72a is replaced by an inverter. The RESET signal is input to the inverter from the reset IC's OUT terminal. Instead of the MASK signal, an output from the inverter just needs to be input to the OR gate 74.

The comparison circuit 73 may be omissible. In this case, the comparator 73a is replaced by an inverter. The high-order address signal A12 is input to the inverter. An output from the inverter just needs to be input to the OR gate 74.

A memory chip can have the 1-Gbit capacity. In this case, it is possible to input address signals A0 through A13 to access corresponding data. Let us assume that there are available a first PC capable of handling the A0 through A12 signals and a second PC capable of handling the A0 through A13 signals. The connected PC inputs a high-order address signal A13 to determine whether or not to cause a state different from the unused state. It may be preferable to generate a determination signal set to a state corresponding to the determination result. In this case, the A13 signal corresponds to the stepwise varying 1-Gbit memory chip capacity while the A12 signal according to the above-mentioned embodiment corresponds to the stepwise varying 256-Mbit memory chip capacity. Let us assume that there are available a first PC capable of handling the A0 through A11 signals and a second PC capable of handling the A0 through A13 signals. A determination signal can be generated by using either the A11 signal or the A12 signal as a high-order address signal. In this case, the A11 or A12 signal corresponds to the stepwise varying 1-Gbit memory chip capacity.

A memory chip can have the 4-Gbit capacity. In this case, it is possible to input address signals A0 through A14 to access corresponding data. Let us assume that there are available a first PC capable of handling the A0 through A13 signals and a second PC capable of handling the A0 through A14 signals. The connected PC inputs a high-order address signal A14 to determine whether or not to cause a state different from the unused state. It may be preferable to generate a determination signal set to a state corresponding to the determination result.

Further, it is possible to apply the modification examples described in the first embodiment to the second embodiment.

As mentioned above, the present invention, in various modes, enables connection to earlier or latest computers independently of their models so that memory chips can be accessed appropriately. It becomes possible to eliminate the need for memory modules specific to computer models.

1. A standardized memory module which is mounted with a memory chip having a stepwise varying capacity based on a specified multiple and, when connected to a computer, enables data access correspondingly to a specified number of address signals and a select signal to indicate a selected or unselected state of a memory space having a capacity corresponding to said specified number of address signals,
wherein any of said address signals corresponds to said stepwise varying memory chip capacity; and
wherein said memory module comprises:
a memory circuit capable of virtually scaling down said memory chip capacity when said computer does not comply with said capacity of mounted memory chip; and
a determination circuit which determines an operation of said memory circuit by determining whether or not said computer complies with said capacity of mounted memory chip.

2. The memory module according to claim 1,
wherein said memory module can be connected to a first computer and a second computer;
wherein said first computer generates a second specified number of address signals fewer than said specified number of address signals and generates a select signal to indicate a selected or unselected state for each of a plurality of memory spaces having a capacity corresponding to said second specified number of address signals;
wherein said second computer generates said specified number of address signals;
wherein said first computer always assigns a specified unused state to a high-order address signal which indicates an address higher than addresses indicated by said second specified number of address signals;
wherein said determination circuit is supplied with said high-order address signal from said computer, determines whether or not said input high-order address signal is set to a state different from said unused state, and generates a determination signal which indicates not only a changed state when said different state is determined, but also an unchanged state when said high-order address signal remains said unused state;
wherein, when said determination signal is set to a changed state, said memory circuit supplies said memory chip with said specified number of address signals supplied from said connected computer to enable said second computer to access corresponding data; and
wherein, when said determination signal is set to an unchanged state, said memory circuit is supplied with said second specified number of address signals and a select signal from said connected computer, generates said high-order address signal based on said supplied select signal, and supplies said memory chip with said high-order address signal and said second specified number of supplied address signals to enable said first computer to access corresponding data.

3. The memory module according to claim 2,
wherein said first computer generates a select signal which indicates a selected or unselected state for each of a plurality of memory spaces having a capacity corresponding to said second specified number of address signals;
wherein said second computer generates a select signal which indicates a selected or unselected state for a memory space having a capacity corresponding to said specified number of address signals;
wherein said memory chip is supplied with a memory select signal to indicate a selected or unselected state and with said specified number of address signals and enables access to data corresponding to said specified number of address signals when said memory select signal indicates a selected state;
wherein, when said determination signal is set to a changed state, said memory circuit is supplied with said specified number of address signals and a select signal from said connected computer, supplies said memory chip with said supplied select signal as said memory select signal, and supplies said memory chip with said specified number of supplied address signals to enable access to corresponding data from said second computer; and
wherein, when said determination signal is set to an unchanged state, said memory circuit is supplied with said second specified number of address signals and a plurality of select signals from said connected computer, generates said memory select signal and a high-order address signal based on said supplied select signal, and supplies said memory chip with said generated memory select signal, said generated high-order address signal, and said second specified number of supplied address signals to enable access to corresponding data from said first computer.

4. The memory module according to claim 3,
wherein said memory circuit comprises:
a first switch circuit which determines connection to a signal line for a high-order address signal of said memory chip to be a signal line for a high-order address signal from said computer when said determination signal indicates said changed state; and to be a signal line for a high-order address signal generated based on said select signal when said determination signal indicates said unchanged state; and
a second switch circuit which determines connection to a signal line for a memory select signal of said memory chip to be a signal line for a select signal from said computer when said determination signal indicates said changed state; and to be a signal line for a memory select signal generated based on said select signal when said determination signal indicates said unchanged state.

5. The memory module according to claim 3,
wherein said memory chip is supplied with a pulse-shaped clock signal and a memory clock enable signal to indicate an enabled or disabled state of said clock signal and can operate based on said clock signal when said clock enable signal is enabled;
wherein said first computer generates a plurality of clock enable signals to indicate an enabled or disabled state of said clock signal input for each of a plurality of memory spaces having a capacity corresponding to said clock signal and said second specified number of address signals;
wherein said second computer generates a clock enable signal to indicate an enabled or disabled state of said clock signal input for a memory space having a capacity corresponding to said clock signal and said specified number of address signals; and
wherein said memory circuit comprises a third switch circuit which, when said determination signal is set to said changed state, determines connection to a memory clock enable signal for said memory chip to be a signal line for clock enable signal from said computer and, when said determination signal is set to said unchanged state, accepts said clock signal and said plurality of clock enable signals from said computer, generates said memory clock enable signal based on said plurality of clock enable signals, and determines connection to a memory clock enable signal for said memory chip to be a signal line for said generated memory clock enable signal.

6. The memory module according to claim 2,
wherein said memory circuit has a power supply line which is supplied with power supply voltage from said first and second computers and supplies power supply voltage to said memory chip;
wherein said determination circuit comprises a stabilization determination circuit and a state holding circuit;
wherein said stabilization determination circuit determines whether or not a potential of said power supply line is smaller than a specified threshold potential, and generates a reset signal which indicates an on-state when said potential is determined to be smaller than said threshold potential and indicates an off-state otherwise; and
wherein said state holding circuit determines whether or not said high-order address signal changes from said unused state to a different state only when said reset signal is in an off-state, sets said determination signal to said changed state and holds it when said high-order address signal changes to said different state, and keeps said determination signal in said unchanged state when said high-order address signal remains said unchanged state.

7. The memory module according to claim 6,
wherein said memory circuit has nonvolatile memory which stores data to be read before access to said memory chip;
wherein said determination circuit has a read start determination circuit which determines whether or not data starts to be read from said nonvolatile memory when said reset signal changes from an on-state to an off-state, generates an on-state mask signal when determining that readout of said data does not start, and generates an off-state mask signal when determining readout of said data starts; and
wherein said state holding circuit determines whether or not said high-order address signal changes from said unused state to a different state only when said mask signal is in an off-state, sets said determination signal to said changed state and holds it when said high-order address signal changes to said different state, and keeps said determination signal in said unchanged state when said high-order address signal remains said unchanged state.

8. The memory module according to claim 7,
wherein said state holding circuit comprises a comparison circuit, a gate circuit, and a hold circuit;
wherein said comparison circuit is supplied with said high-order address signal, compares a potential of said high-order address signal with a specified second threshold potential, outputs a comparison result of a specified first potential when said high-order address signal is in said unused state, and outputs a comparison result of a specified second potential when said high-order address signal is in a state different from said unused state;
wherein said gate circuit outputs a specified third potential signal when said comparison result indicates said second potential and said mask signal is in an off-state, and outputs a specified fourth potential when said comparison result indicates said first potential or said mask signal is in an on-state; and
wherein said hold circuit sets said determination signal to said unchanged state when a signal output from said gate circuit indicates said fourth potential, and sets said determination signal to said changed state when a signal output from said gate circuit indicates said third potential.

9. A memory support module used for a standardized memory module which can be mounted with a memory chip having a stepwise varying capacity based on a specified multiple and, when said memory module is mounted with said memory chip and is connected to a computer, enables data access correspondingly to a specified number of address signals and a select signal to indicate a selected or unselected state of a memory space having a capacity corresponding to said specified number of address signals,
wherein any of said address signals corresponds to said stepwise varying memory chip capacity; and
wherein said memory module comprises:
a memory circuit capable of virtually scaling down said memory chip capacity when said computer does not comply with said capacity of mounted memory chip; and
a determination circuit which determines an operation of said memory circuit by determining whether or not said computer complies with said capacity of mounted memory chip.
